(19) United States
(12) Patent Application Publication
(10) Pub. No.: US 2025/0123163 A1
(43) Pub. Date: Apr. 17, 2025

(54) DIRECT FORCE SENSING ON A THIN PLATE, FOR TRANSVERSE, UNEVEN PRESSURE FIELDS

(71) Applicant: Apple Inc., Cupertino, CA (US)

(72) Inventors: Shyamal Kishore, Sunnyvale, CA (US); Fred Y. Chou, Cupertino, CA (US); Joseph R. Lee, Millbrae, CA (US); Emre Olceroglu, San Francisco, CA (US); Habib S. Karaki, Sunnyvale, CA (US); James C. Clements, Campbell, CA (US)

(21) Appl. No.: 18/913,965

(22) Filed: Oct. 11, 2024

Related U.S. Application Data
(60) Provisional application No. 63/544,138, filed on Oct. 13, 2023.

(51) Int. Cl. G01L 1/22

(52) U.S. Cl. CPC G01L 1/225; G01L 1/2281; G01L 1/2287

(57) ABSTRACT

Dual loop strain gauge architectures (or other multiple loop strain gauge architectures) are used to sense an amount of force applied to an electronic device. The force may be applied by a transverse, uneven pressure field, such as a force that is applied by an amorphous object and/or a force that is applied non-uniformly, over a large area and/or to multiple points or areas. In some embodiments, a dual loop (or other multiple loop) strain gauge architecture is used to sense a pressure distribution on an electronic device. In some embodiments, a single loop strain gauge architecture is used to sense an amount of force applied to an electronic device.

### CROSS-REFERENCE TO RELATED APPLICATION(S)

This application is a nonprovisional patent application of and claims the benefit under 35 U.S.C. § 119 (e) of U.S. Provisional Patent Application No. 63/544,138, filed Oct. 13, 2023, and titled “Direct Force Sensing on a Thin Plate, for Transverse, Uneven Pressure Fields,” the contents of which are incorporated herein by reference in its entirety.

### FIELD

The described embodiments generally relate to force sensing and, more particularly, to sensing a force that is applied to an electronic device by an amorphous object and/or sensing a force that is applied to an electronic device non-uniformly, over a large area and/or to multiple points or areas. Such applications of force are referred to herein as applications of force by a transverse, uneven pressure field.

### BACKGROUND

Many of today's electronic devices include one or more force sensors. For example, a force sensor may be used to sense an amount of force applied to a touch screen, an amount of force applied to a button or crown, or an amount of force applied to a device housing. Typically, a force sensor will redirect an applied force to one or more discrete load cells. However, a load cell (or cells) may be less useful (e.g., less accurate) when sensing a force that is applied to an electronic device by an amorphous object, or when sensing a force that is applied to an electronic device non-uniformly, over a large area and/or to multiple points or areas. Also, and in some cases, the use of a load cell may be undesirable due to its bulk, or because the load cell is not compatible with a device absent a significant redesign of the device. A force sensor that is better suited to force sensing in these applications would be useful.

### SUMMARY

Embodiments of the systems, devices, methods, and apparatus described in the present disclosure employ single or dual loop strain gauge architectures (or other multiple loop strain gauge architectures) to sense an amount of force applied to an electronic device. In some embodiments, a dual loop (or other multiple loop) strain gauge architecture may be used to sense a pressure distribution on an electronic device. In some embodiments, supplementary loops may be incorporated to compensate for a temperature coefficient of resistance (TCR). In some variations of these embodiments, the supplementary loops can be formed from diverse materials having unique gauge factors, TCRs, etc., arranged in electrically interconnected configurations. Alternatively, and in some embodiments, the additional loops may not be electrically connected, yet their outputs may be utilized for arithmetic compensation during post-processing of strain gauge or other measurements. To bolster the signal-to-noise ratio (SNR) of a sensor, sections of the loops may be rewired electrically, or the loops may be provided on opposing sides of a substrate (e.g., a thin film, flexible printed circuit, or rigid printed circuit board (PCB) substrate) to establish a full Wheatstone Bridge configuration. In some embodiments, the loops may not be circular and can be designed for compatibility within a boundary (or boundaries) of a surfaces of interest.

In one aspect, an electronic device is described. The electronic device may include a substrate and a force sensor. The force sensor may include at least one strain-sensitive resistor formed on or attached to the substrate. The at least one strain-sensitive resistor may define at least one loop bounding an area of the substrate. A loop of the at least one loop may include a number of strain-sensitive resistors disposed end-to-end along a length of the loop. Each strain-sensitive resistor of the at least one strain-sensitive resistor may include a set of rosette elements.

In another aspect, another electronic device is described. The electronic device may include a substrate and a force sensor. The force sensor may include a set of strain-sensitive resistors formed on or attached to the substrate. The set of strain-sensitive resistors may define at least one loop pair bounding an area of the substrate. A loop pair of the at least one loop pair may include a first loop and a second loop. The first loop may include a first number of strain-sensitive resistors disposed end-to-end along a first length of the first loop. The second loop may include a second number of strain-sensitive resistors disposed end-to-end along a second length of the second loop. Each strain-sensitive resistor of the at least one strain-sensitive resistor may include a set of rosette elements.

In another aspect, a wearable device is described. The wearable device, may include a housing that defines a skin-contacting housing member. The skin-contacting housing member may have a skin contact region. The wearable device may also include a force sensor. The force sensor may include a set of strain-sensitive resistors formed on or attached to the skin-contacting housing member. The set of strain-sensitive resistors may define at least one loop circumscribing the skin contact region. A loop of the at least one loop may include a number of strain-sensitive resistors disposed end-to-end along a length of the loop. Each strain-sensitive resistor of the at least one strain-sensitive resistor may include a set of rosette elements.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A, 1B, and 1C show example structures on which a single or multiple loop strain gauge architecture may be formed, or to which a single or multiple loop strain gauge architecture may be attached.

FIGS. 2A, 2B, and 2C show plan views of example dual loop strain gauge architectures.

FIG. 3 shows an example free body diagram of two adjacent rosette elements of one of the loops of the dual loop strain gauge architecture shown in FIG. 2.

FIG. 4A shows an example circuit schematic in which the resistors of a dual loop strain gauge architecture are electrically connected in a full Wheatstone Bridge configuration.

FIG. 4B shows an example dual loop strain gauge architecture having three pixels, with each resistor of the strain gauge architecture having branched electrodes.

FIG. 5 shows an example application of a transverse, uneven pressure field applied to the dual loop strain gauge shown in FIG. 2C.

FIG. 6A shows an example quad loop strain gauge architecture having a set of resistors disposed on one surface of a substrate, and FIG. 6B shows an example quad loop strain gauge architecture having a set of resistors distributed on two opposing surfaces of a substrate.

FIG. 7 shows an example dual loop strain gauge architecture in which each of an outer loop and an inner loop is segmented into more than two resistors, with corresponding pairs of outer and inner loop resistors having the same angular extent.

FIG. 8 shows an example single loop strain gauge architecture.

FIGS. 9A and 9B show an example dual loop strain gauge architecture having one or more thermal short circuit paths.

FIGS. 10A-10E show various alternative rosette elements that may be used in any of the strain gauge architectures described herein.

FIG. 11 shows a practical implementation of the rosette elements shown in FIG. 10A, in a quad loop strain gauge architecture.

FIG. 12 shows a cross-section of an example single loop strain gauge architecture, in which the loop includes first and second stacked materials.

FIGS. 13A and 13B show an example of a device that includes a strain gauge architecture.

FIG. 14 shows an example block diagram of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The strain gauge architectures described herein stem from rigorous mathematical analysis of thin plate theory, specifically focused on transverse point load solutions. In-depth mathematical examination of a plate's deformation under concentrated, eccentric loads provides design insights extendable to distributed pressure loads based on the principle of superposition.

A unified strain gauge architecture is proposed to measure the integrated transverse force between contacting surfaces, irrespective of the pressure distribution. Such heterogeneous pressure topographies frequently arise during contact between rigid metal surfaces and soft biological tissues. Unlike conventional force sensors that redirect contact forces from the interacting surfaces to discrete load cells attached to the main surface, the proposed strain gauge architectures integrate a novel strain gauge design on the interacting metal surface itself, reducing system complexity, mass, and spatial volume requirements.

In some embodiments described herein, a strain gauge architecture includes concentric outer and inner loops (e.g., dual loops) of strain-sensitive resistors. A difference in strain measurements between the outer and inner loops is independent of the distribution of a load applied to a plate on which the strain gauge architecture is formed, or to which the strain gauge architecture is attached. The difference in strain measurements is only dependent on the load value, the plate's dimensions, the plate's material properties, and the geometry of the strain gauge architecture. The difference in strain measurements is also independent of the gap between the loops, as long as the inner loop fully contains the applied force (e.g., none of the force is applied at points between the outer and inner loops).

A larger gap between the outer and inner loops increases the magnitude of the measured signal. With no gap, the signal is zero. However, too large a gap can increase the strain gauge architecture's susceptibility to thermal gradients and introduce greater error as a result of loads applied between the outer and inner loops. Loads applied outside the outer loop do not contribute to the difference in strain between the outer and inner loops and, thus, do not contribute to the output signal. Loads applied between the outer and inner loops are measured and may introduce some small amount of error.

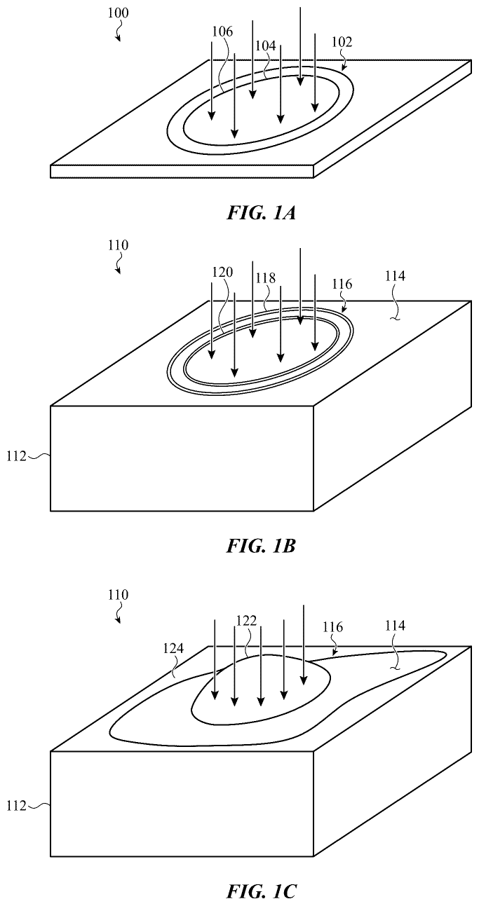

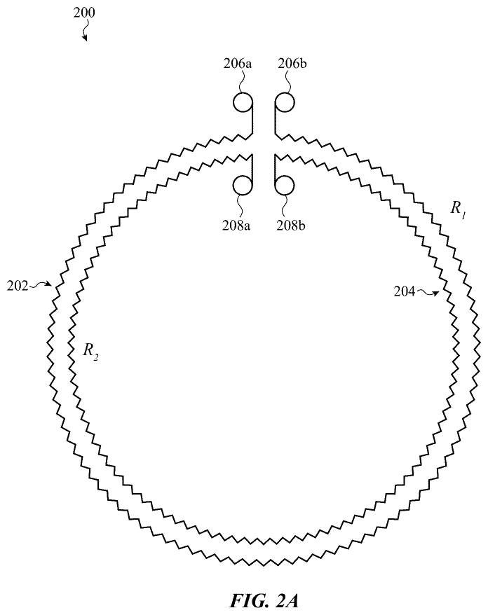

These and other systems, devices, methods, and apparatus are described with reference to FIGS. 1A-14. However, those skilled in the art will readily appreciate that the detailed description given herein with respect to these figures is for explanatory purposes only and should not be construed as limiting.

Directional terminology, such as “top,” “bottom,” “upper,” “lower,” “front,” “back,” “over,” “under,” “above,” “below,” “left,” “right,” etc. is used with reference to the orientation of some of the components in some of the figures described below. Because components in various embodiments can be positioned in a number of different orientations, directional terminology is used for purposes of illustration and is not always limiting. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

FIGS. 1A, 1B, and 1C show example structures on which a single or multiple loop (e.g., dual loop) strain gauge architecture (or force sensor) may be formed, or to which a single or multiple loop strain gauge architecture may be attached. By way of example, FIG. 1A shows a plate (or substrate) 100 having a generally square shape. Alternatively, the plate 100 could have other shapes (e.g., a rectangular, circular, or other type of shape). The plate 100 may be composed of any number of materials, such as glass, sapphire, zirconia, aluminum, stainless steel, titanium, or plastic. In some embodiments, the plate 100 may be, or be part of, a housing member (e.g., part or all of a device housing). The plate 100 may have a maximum thickness, D, which in some cases may depend, at least in part, on the material that forms the plate 100. However, generally, the maximum thickness should be small enough that mathematical thin plate theory applies to the plate 100.

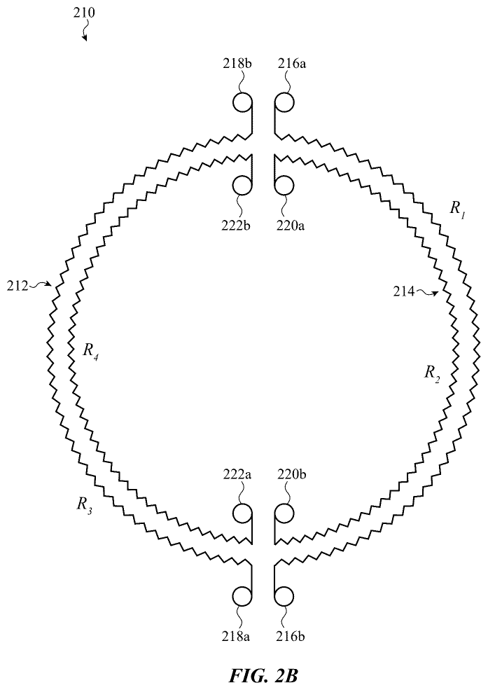

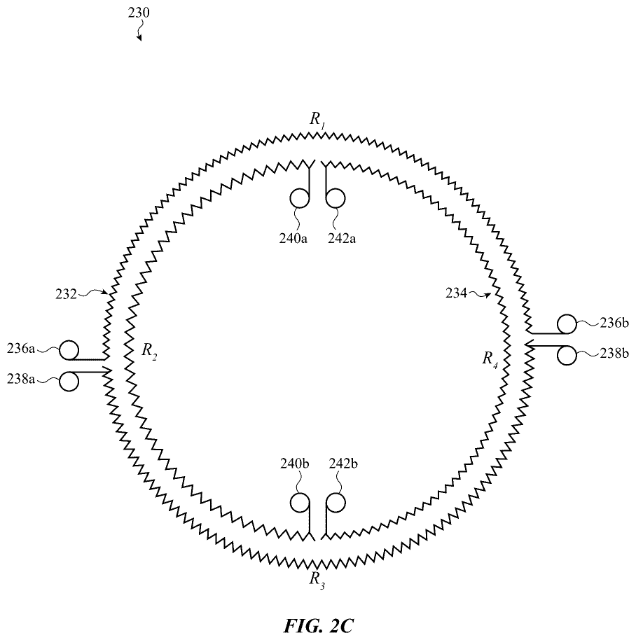

A single loop or multiple loop (e.g., dual loop) strain gauge architecture 102 may be formed on (e.g., by sputtering), or attached to (e.g., by means of a flexible printed circuit (FPC) containing the strain gauge architecture 102), the plate 100. As described with reference to FIGS. 2A-14, the strain gauge architecture 102 may include, for example, one, two, or four concentric loops, with each loop being defined by two or more strain-sensitive resistors. The loop(s) may be circular, as shown, or alternatively could be oval, square, rectangular, or any other shape. By way of example, FIG. 1A shows a strain gauge architecture 102 having two circular loops 104, 106.

The strain gauge architecture 102 may be used to measure an amount of force applied to the plate 100, within the area bounded by the inner loop 106 of the strain gauge architecture 102. The strain gauge architecture 102 may be designed such that a force applied to the plate 100 outside the outer loop 104 of the strain gauge architecture 102 is not measured by the strain gauge architecture 102.

FIG. 1B shows a three-dimensional object 110 having an internal volume 112. The object 110 may be defined, in part, by a plate (or substrate) 114 that defines one surface of the object 110. In various embodiments, the object 110 may be a computer (e.g., a laptop computer, a tablet computer, or a desktop computer), a wearable device (e.g., a body of a watch, fitness tracker, or other wrist-worn device; an earphone; an earbud; a head-mounted device (HMD) or set of eyeglasses; or a body of an arm-worn, leg-worn, or head-worn device (e.g., a blood pressure cuff, a headset, goggles, or glasses)), a game controller or remote controller, a gaming peripheral (e.g., a glove or weapon), an appliance, a diagnostic device, a touch screen, an input device (e.g., a mouse or touch pad), etc. By way of example, the plate 114 may be part of (e.g., a housing member of) a device housing, a device cover, or a protective layer disposed over a display. The plate 114 may be integrally formed with other parts of the object 110, or the plate 114 may be a component that is attached to other parts of the object 110. Although the object 110 is shown to have six orthogonal sides, the object 110 may have more or fewer sides, some of which may have curved or irregularly shaped perimeters or surface contours.

Similarly to the plate 100, the plate 114 may be composed of any number of materials, such as glass, sapphire, zirconia, aluminum, stainless steel, titanium, or plastic. The plate 114 may have a maximum thickness, D, which in some cases may depend, at least in part, on the material that forms the plate 114. However, generally, the maximum thickness should be small enough that mathematical thin plate theory applies to the plate 114.

A single loop or multiple loop (e.g., dual loop) strain gauge architecture 116 may be formed on (e.g., by sputtering), or attached to (e.g., by means of an FPC containing the strain gauge architecture 116), the plate 114. As described with reference to FIGS. 2-14, the strain gauge architecture 114 may include, for example, one, two, or four concentric loops, with each loop being defined by two or more strain-sensitive resistors. The loop(s) may be circular, as shown, or alternatively could be oval, square, rectangular, or any other shape. By way of example, FIG. 1B shows a strain gauge architecture 102 having two loop pairs 118, 120 (e.g., a quad loop strain gauge architecture), with each loop pair 118, 120 having respective, concentric, first and second loops.

FIG. 1C shows an alternative embodiment of the three-dimensional object 110, in which one or more protrusions 122 extend from a portion of the plate 114 bounded by the strain gauge architecture 114. The one or more protrusions 122 may be integrally formed with the plate 114 or may represent one or more objects that are attached to the plate 114. In some embodiments, the one or more protrusions 122 may be a singular dome-shaped structure having a planar back surface that is attached to the plate 114 along a perimeter of an opening defined by the plate 114. Alternatively, the plate 114 may not define an opening under the one or more protrusions 122.

The strain gauge architecture 116 may be used to measure a force applied to the one or more protrusions 122. For example, a person may press the one or more protrusions 122 against a portion of their body or clothing, and the strain gauge architecture 116 may be used to measure the force applied by their body or clothing to the plate 114. By way of example, FIG. 1C shows a strain gauge architecture 102 having a single loop 124 of irregular shape.

The strain gauge architecture described with reference to any of FIGS. 1A-1C should be applied to a flat portion of the plate (or substrate, or housing, or housing member) 100 or 114. The resistors of the strain gauge architecture may be electrically connected to circuitry including discrete components, a controller, and/or a processor that executes a dynamic or stored program, which circuitry may acquire and interpret measurements obtained from the strain gauge architecture. In some embodiments, the circuitry may convey a measurement to a user by means of a display, an alarm, a haptic output, or other means. In some embodiments, the circuitry may trigger one or more operations in response to acquiring a measurement, or in response to determining that the measurement satisfies a threshold. The one or more operations may include one or more of saving the measurement, reporting the measurement, launching an application, etc.

A first example dual loop strain gauge architecture (or force sensor) 200 that may be formed on, or attached to, any of the plates (or substrates, or housings, or housing members) described with reference to FIGS. 1A-1C (or other plates or substrates) is shown in FIG. 2A. The dual loop strain gauge architecture 200 may include an outer loop 202, including resistor R₁ (e.g., a strain-sensitive resistor), and an inner loop 204, including resistor R₂ (e.g., another strain-sensitive resistor). Resistor R₁ may be disposed end-to-end, along a length of the loop 202 or resistor R₁, to define an almost continuous loop 202 between terminal 206a (e.g., a first electrical contact pad or via) at one end of resistor R₁ and terminal 206b (e.g., a second electrical contact pad or via) at the other end of resistor R₁. Similarly, resistor R₂ may be disposed end-to-end, along a length of the loop 204 or resistor R₂, to define an almost continuous loop 204 between terminal 208a (e.g., a first electrical contact pad or via) at one end of resistor R₁ and terminal 208b (e.g., a second electrical contact pad or via) at the other end of resistor R₁.

A second example dual loop strain gauge architecture (or force sensor) 210 that may be formed on, or attached to, any of the plates (or substrates, or housings, or housing members) described with reference to FIGS. 1A-1C (or other plates or substrates) is shown in FIG. 2B. The dual loop strain gauge architecture 210 may include an outer loop 212, including resistors R₁ and R₃ (e.g., two strain-sensitive resistors), and an inner loop 214, including resistors R₂ and R₄ (e.g., two more strain-sensitive resistors). Resistors R₁ and R₃ may be disposed end-to-end, along a length of the loop 212, to define an almost continuous outer loop 212, with resistor R₁ extending between terminals 216a and 216b of a first set of terminals (e.g., a first set of electrical contact pads or vias), and with resistor R₃ extending between terminals 218a and 218b of a second set of terminals (e.g., a second set of electrical contact pads or vias). Similarly, resistor R₂ and R₄ may be disposed end-to-end, along a length of the loop 214, to define an almost continuous inner loop 214, with resistor R₂ extending between terminals 220a and 220b (e.g., a third set of electrical contact pads or vias), and with resistor R₄ extending between terminals 222a and 222b (e.g., a fourth set of electrical contact pads or vias). The angular extent of the resistor R₂ may be aligned (or approximately aligned) with respect to the angular extent of the resistor R₁. Similarly, the angular extent of the resistor R₄ may be aligned (or approximately aligned) with the angular extent of the resistor R₄.

A third example dual loop strain gauge architecture (or force sensor) 230 that may be formed on, or attached to, any of the plates (or substrates, or housings, or housing members) described with reference to FIGS. 1A-1C (or other plates or substrates) is shown in FIG. 2C. The dual loop strain gauge architecture 230 may include an outer loop 232, including resistors R₁ and R₃ (e.g., two strain-sensitive resistors), and an inner loop 234, including resistors R₂ and R₄ (e.g., two more strain-sensitive resistors). Resistors R₁ and R₃ may be disposed end-to-end, along a length of the loop 232, to define an almost continuous outer loop 232, with resistor R₁ extending between terminals 236a and 236b of a first set of terminals (e.g., a first set of electrical contact pads or vias), and with resistor R₃ extending between terminals 238a and 238b of a second set of terminals (e.g., a second set of electrical contact pads or vias). Similarly, resistors R₂ and R₄ may be disposed end-to-end, along a length of the loop 234, to define an almost continuous inner loop 234, with resistor R₂ extending between terminals 240a and 240b of a third set of terminals (e.g., a third set of electrical contact pads or vias), and with resistor R₄ extending between terminals 242a and 242b of a fourth set of terminals (e.g., a fourth set of electrical contact pads or vias). The angular extent of the resistor R₂ may be offset 90° with respect to the angular extent of the resistors R₁ and R₃. Similarly, the angular extent of the resistor R₄ may be offset 90° with respect to the angular extent of the resistor R₂ and R₄.

The dual loop strain gauge architectures shown in FIGS. 2A-2C allow for variations in thermal strain to be canceled from the average strain output(s) of the strain gauge architecture. For example, the strain output of each pixel in a dual loop strain gauge architecture may be a difference in strain measurements between the respective outer and inner loops of the dual loop strain gauge architecture (or between corresponding outer and inner loop resistors in a “pixel” of a dual loop strain gauge architecture). When there are multiple pixels, the total force in such cases is calculated as proportional to the mean of the pixel outputs. In some embodiments, each of the dual loop strain gauge architectures shown in FIGS. 2A-2C may be wired as a single pixel force sensor. The dual loop strain gauge architecture shown in FIG. 2A may alternatively be wired as a two pixel force sensor.

Although all of the loops shown in FIGS. 2A-2C are circular, the loops may have other simple (standard) or complex (irregular) shapes. However, the loops of a multiple loop (e.g., dual loop) strain gauge architecture should all have the same shape, and should have a uniform separation along the lengths of adjacent loops.

Each of the resistors R₁, R₂, R₃, R₄ shown in FIGS. 2A-2C may take different forms but may include a set of rosette elements (e.g., elements having radial and/or angular differences (e.g., differences in radius (r) and/or angle (θ))). In some embodiments, each resistor R₁, R₂, R₃, and R₄ may include a set of continuously linked rosette elements, with each rosette element including a pair of orthogonal segments. Each orthogonal segment may be oriented at approximately 45 degrees (˜±45°) with respect to a local radius vector. The effect of such rosette elements is to measure a local sum of orthogonal normal strains.

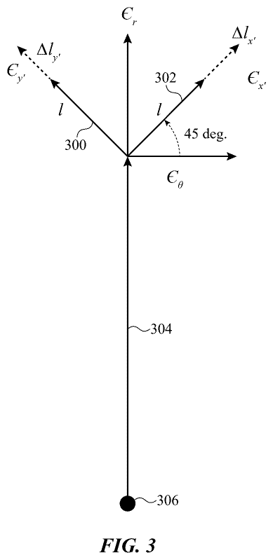

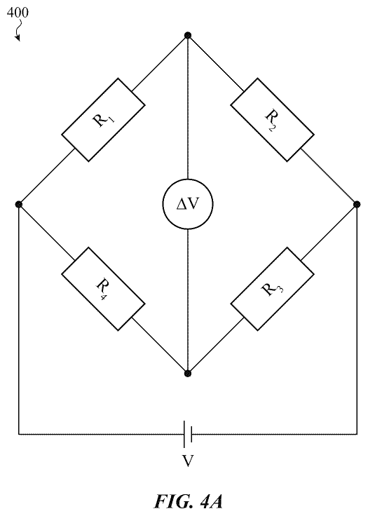

A free body diagram of two adjacent segments 302, 304 of a rosette element 300 of the outer loop 232 in FIG. 2A or 2C is shown in FIG. 3. A local radius vector 306 extends from a center axis 308 of the dual loop strain gauge architecture 230 shown in FIG. 2A or 2C, toward a radially innermost juncture between two adjacent segments of a rosette element of the outer loop 232 (e.g., toward the juncture between the two adjacent segments 300, 302). Strain vectors εᵣ and ε_{θ} may be respectively defined inline (e.g., aligned with) and perpendicular to (e.g., orthogonal to) the local radius vector 306. These strain vectors (εᵣ and ε_{θ}) may be related to a set of strain vectors (εₓ and ε_{y}) aligned with the lengths of the adjacent segments 300, 302, with ε_{x′} and ε_{y′} being aligned with a coordinate system that is rotated 45° with respect to the coordinate system of εᵣ and ε_{θ}. The strain vectors εᵣ, ε_{θ}, ε_{x′}, and ε_{y′} are mathematically related as follows:

$${ε}_{{x}^{′}} = {ε}_{r} {cos}^{2} θ + {ε}_{θ} {sin}^{2} θ + {γ}_{r θ} cos θ sin θ$$

$${ε}_{{y}^{′}} = {ε}_{r} {sin}^{2} θ + {ε}_{θ} {cos}^{2} θ - {γ}_{r θ} cos θ sin θ$$

$${ε}_{{x}^{′}} + {ε}_{{y}^{′}} = {ε}_{r} + {ε}_{θ}$$

Each segment 300, 302 (and all of the segments of all of the rosette elements of a resistor R₁, R₂, R₃, or R₄) may have a same length, l, which may expand by a length Δl_{x′} or Δl_{y}_{ⁱ} in response to strain.

A similar εᵣ_{ᵢ}, ε_{θ}_{ᵢ}, ε_{x′}_{ᵢ}, and ε_{y′}_{ᵢ} may be defined for a set of adjacent segments of an adjacent rosette element and local radius vector i., for each of the outer loop 232 and the inner loop 234, and for each of the resistors R₁, R₂, R₃, and R₄. A reduction in the dimensions (or increase in the granularity) of the segments of the rosette elements of each resistor R₁, R₂, R₃, and R₄ may increase the accuracy (or resolution) of the force sensing capability of the dual loop strain gauge architecture 230, so long as the material and manufacturing process used to form the rosette elements allows for sufficient definition of the different rosette elements (and the segments thereof). Accuracy (or resolution) may be increased by virtue of there being more rosette elements associated with more local radius vectors, which local radius vectors may be more closely spaced in an angular direction.

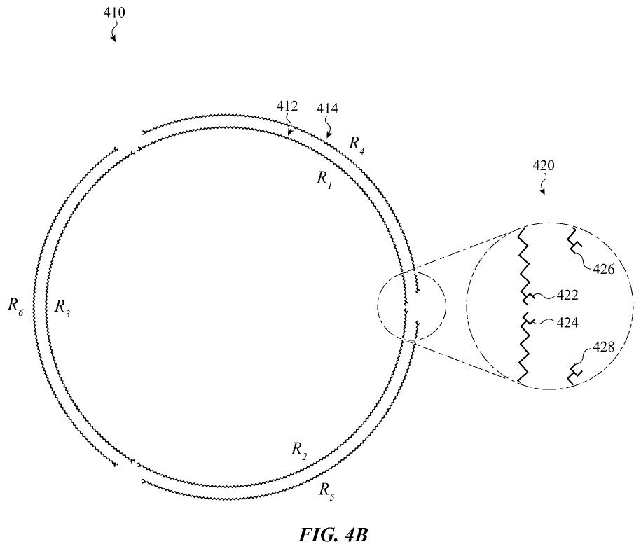

The various resistors of a multiple loop (e.g., dual loop) strain gauge architecture may be electrically connected in various ways. For example, FIG. 4A shows a schematic of a Wheatstone Bridge 400 having resistors R₁, R₂, R₃, and R₄. Resistors R₁ and R₂ are connected in series; resistors R₃ and R₄ are connected in series; and the series combination of resistors R₁ and R₂ is coupled in parallel with the series combination of resistors R₃ and R₄, and in parallel with a voltage source (e.g., a source of a voltage, V). An output, ΔV, may be measured between the juncture of resistors R₁ and R₂ and the juncture of resistors R₃ and R₄. The resistors of the dual loop strain gauge architecture shown in FIG. 2A may be connected in a half Wheatstone bridge configuration (e.g., as resistors R₁ and R₂ (or alternatively, as resistors R₁ and R₃) of the Wheatstone Bridge 400, with the remaining resistors being reference resistors that are not subjected to mechanical strain (and preferably not to thermal strain). The resistors of the dual loop strain gauge architecture shown in FIG. 2B or 2C may be connected in a full Wheatstone bridge configuration (e.g., as resistors R₁-R₄ of the Wheatstone Bridge 400).

In accordance with the layout of the Wheatstone Bridge 400:

$$Δ V = \frac{{R}_{2} {R}_{1}}{{( {R}_{2} + {R}_{1} )}^{2}} \{ \frac{Δ {R}_{1}}{{R}_{1}} - \frac{Δ {R}_{2}}{{R}_{2}} + \frac{Δ {R}_{3}}{{R}_{3}} - \frac{Δ {R}_{4}}{{R}_{4}} \}$$

The output of a dual loop strain gauge architecture may be related to a transverse load applied to a point or points, or area or areas, within or outside the dual loop strain gauge architecture, as follows, where the strain of each resistor R₂, R₃, and R₄

$$( e . g . , {ε}_{{loop}_{{R}_{2}}} , {ε}_{{loop}_{{R}_{3}}} , and {ε}_{{loop}_{{R}_{4}}} )$$

is calculated similarly to the strain

$$( {ε}_{{loop}_{{R}_{1}}} )$$

of resistor R₁, as follows (where n is the number of rosette elements of a resistor):

$$\begin{matrix}{ε}_{{loop}_{{R}_{1}}} & = \frac{{\sum }_{i = 1}^{n / 2} ( Δ {l}_{{x}_{i}^{′}} + Δ {l}_{{y}_{i}^{′}} )}{2 l ( n / 2 )} \\ & = \frac{1}{n} {\sum }_{i = 1}^{n / 2} ( \frac{Δ {l}_{{x}_{i}^{′}}}{l} + \frac{Δ {l}_{{y}_{i}^{′}}}{l} ) \\ & = \frac{1}{n} {\sum }_{i = 1}^{n / 2} ( {ε}_{{x}_{i}^{′}} + {ε}_{{y}_{i}^{′}} ) \\ & = \frac{{\sum }_{i = 1}^{n / 2} ( {ε}_{{x}_{i}^{′}} + {ε}_{{y}_{i}^{′}} )}{n}\end{matrix}$$

$${ε}_{{loop}_{{R}_{1}}} = \{ \frac{1}{π} {\int }_{0}^{π} ( {ε}_{r} + {ε}_{θ} ) d θ \} + Error$$

Combining the strains of the resistors in the outer loop yields:

$${ε}_{{loop}_{{R}_{1}}} + {ε}_{{loop}_{{R}_{3}}} = \{ \frac{1}{π} {\int }_{0}^{π} ( {ε}_{r} + {ε}_{θ} ) d θ \} + \{ \frac{1}{π} {\int }_{π}^{2 π} ( {ε}_{r} + {ε}_{θ} ) d θ \} + Error$$

The strains of the resistors in the inner loop may be calculated similarly. The difference in strain between the inner and outer loops may be calculated, and related to the output of the Wheatstone Bridge 400 shown in FIG. 4A, as follows:

$${ε}_{{loop}_{{R}_{1}}} + {ε}_{{loop}_{{R}_{3}}} - {ε}_{{loop}_{{R}_{2}}} - {ε}_{{loop}_{{R}_{4}}} = \{ \frac{Δ {R}_{1}}{{R}_{1}} + \frac{Δ {R}_{3}}{{R}_{3}} - \frac{Δ {R}_{2}}{{R}_{2}} - \frac{Δ {R}_{4}}{{R}_{4}} \} = 2 \{ {[ \frac{1}{2 π} {\int }_{0}^{2 π} ( {ε}_{r} + {ε}_{θ} ) d θ ]}_{r = c} - {[ \frac{1}{2 π} {\int }_{0}^{2 π} ( {ε}_{r} + {ε}_{θ} ) d θ ]}_{r = c - δ c} \} + Error$$

Each of the loops (e.g., the outer and inner loops of the dual loop strain gauge architecture shown in FIG. 2B or 2C) measures an average sum of strains in mutually orthogonal axes (e.g., r and θ, or x and y), and the difference of the loop measurements is directly proportional to the total force, P, captured inside the inner loop. This can be seen from the derived governing equations:

$${[ \frac{1}{2 π} {\int }_{0}^{2 π} ( {ε}_{r} + {ε}_{θ} ) d θ ]}_{r = c} - {[ \frac{1}{2 π} {\int }_{0}^{2 π} ( {ε}_{r} + {ε}_{θ} ) d θ ]}_{r = c - δ c} = \frac{\pm Ph}{4 π D} [ log \frac{c}{a} - log \frac{c - δ c}{a} ]$$

$$where c > b$$

$${[ \frac{1}{2 π} {\int }_{0}^{2 π} ( {ε}_{r} + {ε}_{θ} ) d θ ]}_{r = c} - {[ \frac{1}{2 π} {\int }_{0}^{2 π} ( {ε}_{r} + {ε}_{θ} ) d θ ]}_{r = c - δ c} = 0 when c < b$$

where a is the radius of a thin plate containing a dual loop strain gauge architecture; b is the radius of a centroid location of a force applied to the thin plate; c is the radius of the inner loop of the dual loop strain gauge architecture; D is plate stiffness parameter; and h is a uniform thickness of the thin plate.

As an alternative to electrically connecting the resistors of a dual loop (or other multiple loop) strain gauge architecture in a half or full Wheatstone Bridge configuration, a voltage (or resistance) of each resistor in a dual loop strain gauge architecture may be separately measured or determined. For example, FIG. 4B shows a dual loop strain gauge architecture 410 having an inner loop 412 and an outer loop 414, with each loop 412, 414 having three resistors disposed end-to-end along a length of the loop 412 or 414. The inner loop 412 has resistors R₁, R₂, and R₃, and the outer loop 414 has resistors R₄, R₅, and R₆. Each of the resistors has a branching electrode at either end (e.g., an electrode having two electrical connection points or terminals). For example, as shown in more detail in an exploded view 420 of a portion of the dual loop strain gauge architecture 410, resistors R₁, R₂, R₄, and R₅ each have a respective branching electrode 422, 424, 426, 428 at one end thereof. Each of these resistors may have another respective branching electrode at the other end thereof. An electrical connection may be made to each branch or terminal, of each branching electrode, so that a 4-wire measurement technique may be used to measure a voltage across, or determine a resistance of, each resistor R₁, R₂, R₃, R₄, R₅, or R₆. A composite strain or force may then be determined algorithmically, in a digital domain, instead of automatically, in an analog domain (as may be done using the Wheatstone Bridge of FIG. 4A.

FIG. 4B is also notable in that it shows a three pixel dual loop strain gauge architecture, in which measurements acquired for a first pixel, including resistors R₁ and R₄, can be used to determine a first strain or force measurement; measurements acquired for a second pixel, including resistors R₂ and R₅, can be used to determine a second strain or force measurement; and measurements acquired for a third pixel, including resistors R₃ and R₆, can be used to determine a third strain or force measurement. In some embodiments, the measurements of the three pixels may be averaged to determine a total force measurement.

In contrast to what is shown in FIG. 2B, where corresponding resistors in an inner loop and outer loop are angularly aligned, corresponding resistors in the embodiment of FIG. 4B are not angularly aligned. That is, each resistor in the outer loop 414 has a smaller angular extent than a corresponding resistor in the inner loop 412. For example, resistor R₄ has a smaller angular extent than resistor R₁. Resistors R₄ and R₁ do, however, have a same length.

As yet another option of electrically connecting the resistors of a dual loop strain gauge architecture, the resistors of a pixel in a dual loop strain gauge architecture may be electrically connected to a pair of voltage divider circuits. For example, each pair of corresponding resistors of the dual loop strain gauge architecture shown in FIG. 4B may be electrically connected in a respective voltage divider circuit. In embodiments in which each of an outer loop and an inner loop include only a single respective resistor, the resistors may be electrically connected in a single voltage divider circuit.

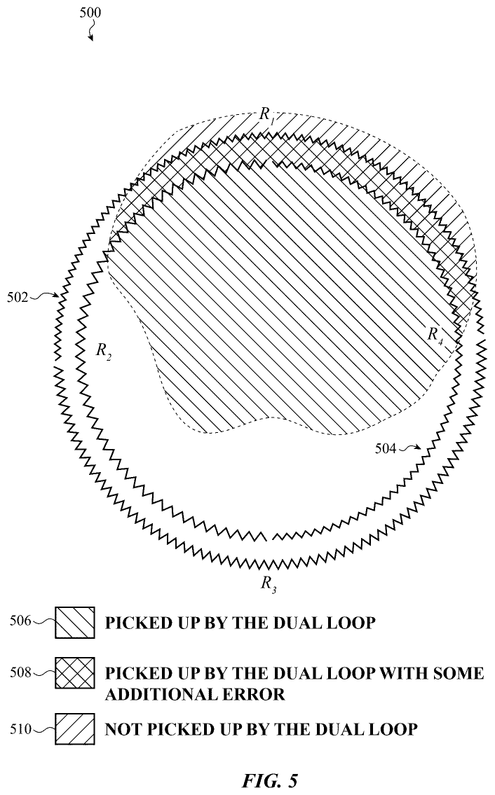

A dual loop strain gauge architecture fully measures all of the loads (or forces) applied inside its inner loop and does not measure any of the loads applied outside its outer loop. For example, and as shown in FIG. 5, the loads applied within region 506 are measured by the dual loop strain gauge architecture 500 including outer loop 502 and inner loop 504; the loads applied within region 508 are measured with some error; and the loads applied within region 510 are not measured.

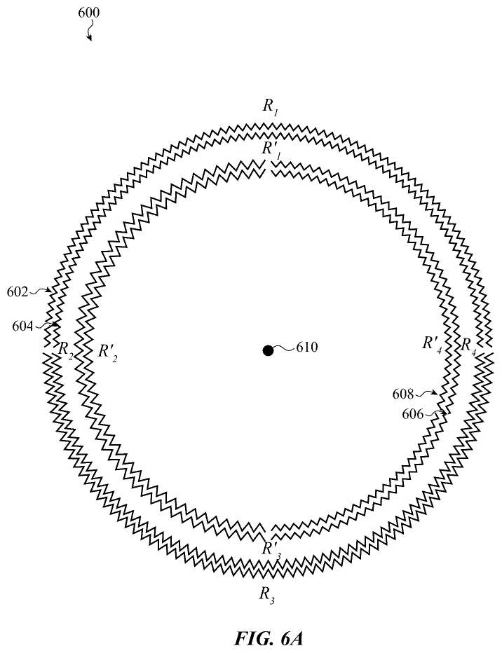

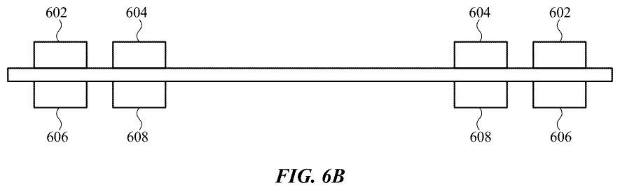

The dual loop strain gauge architectures of FIGS. 2A-2C, 4B, and 5 provide automatic compensation for temperature effects as long as the gap between the inner and outer loops is small, such that portions of the inner and outer loops having the same angular positions have substantially the same thermal exposures. However, to better address temperature compensation issues, a quad loop strain gauge architecture may be used, in which a bi-material design can be used. For example, as shown in FIG. 6A, a pair of outer loops of a quad loop strain gauge structure 600 may include concentric first and second loops 602, 604, with the first loop 602 being formed of a first material and the second loop 604 being formed of a second material (e.g., a material different from the first material). Similarly, a pair of concentric inner loops 606, 608 (concentric with each other and concentric with the pair of outer loops 602, 604) may include a third loop 606 formed of a third material and a fourth loop 608 formed of a fourth material (e.g., a material different from the third material). The first loop 602 may include a resistor R₁ and a resistor R₃. The second loop 604 may include a resistor R₁′ and a resistor R₃′. The third loop 606 may include a resistor R₂ and a resistor R₄. The fourth loop 608 may include a resistor R₂′ and a resistor R₄′. The resistors R₁, R₂, R₃, and R₄ may be connected to form a first Wheatstone Bridge as shown in FIG. 4, and the resistors R₁′, R₂′, R₃′, and R₄′ may be connected to form a second Wheatstone Bridge as shown in FIG. 4. The resistors R₁ and R₁′ may span the same (or similar) angular extent about a center axis 610 of the quad loop strain gauge structure 600. Similarly, the resistors R₂ and R₂′ may span the same angular extent; the resistors R₃ and R₃′ may span the same angular extent; and the resistors R₄ and R₄′ may span the same angular extent. The angular extents of the resistors R₂ and R₂′ may be offset 90° with respect to the angular extents of the resistors R₁ and R₁′. Similarly, the angular extents of the resistors R₄ and R₄′ may be offset 90° with respect to the angular extents of the resistors R₂ and R₂′. Alternatively, resistors R₁, R₁′, R₃, and R₃′ may all span the same angular extent, and resistors R₂, R₂′, R₄, and R₄′ may all span the same angular extent.

In some embodiments, one of the first or second materials may be the same as one of the third or fourth materials, and the other of the first or second materials may be the same as the other of the third or fourth materials. Stated differently, one of the outer loops 602, 604 may be formed of the same material as one of the inner loops 606, 608, and the other one of the outer loops 602, 604 may be formed of the same material as the other one of the inner loops 606, 608. Alternatively, each of the first, second, third, and fourth materials may be a different material. As yet another alternative, both of the outer loops 602, 604 may be formed of a first material, and both of the inner loops 606, 608 may be formed of a second material different from the first material.

The loops in the pair of outer loops 602, 604 may be positioned closer together than the innermost one of the outer loops 602, 604 is positioned to the outermost one of the inner loops 606, 608. Similarly, the loops in the pair of inner loops 606, 608 may be positioned closer together than the outermost one of the inner loops 606, 608 is positioned to the innermost one of the outer loops 602, 604. Stated differently, the outer loops (an outer loop pair) 602, 604 may be separated from the inner loops (an inner loop pair) 606, 608 by a first separation distance; the outer loops 602, 604 may be separated by a second separation distance; and the inner loops 606, 608 may be separated by a third separation distance, with the first separation distance being greater than the second separation distance and greater than the third separation distance.

In a quad loop strain gauge architecture 600 including resistors formed by two different materials, the two materials may have dissimilar thermal-mechanical responses to the same strain-field (e.g., A and A′ may respectively depend on the different gauge factors of the two materials, and B and B′ may depend on the different thermal expansion characteristics of the two materials). In such an architecture:

$$Δ {V}_{total} = A Δ {V}_{mech .} + B Δ {V}_{therm .} \\ Δ {V}_{total}^{′} = {A}^{′} Δ {V}_{mech .} + {B}^{′} Δ {V}_{therm .}$$

where ΔVₜₒₜₐₗ and ΔV′ₜₒₜₐₗ are the respective outputs of the two Wheatstone Bridges.

In an alternative to what is described above and with reference to FIG. 6A, the resistors R₁, R₂, R₁′, and R₂′ may be connected to form a first Wheatstone Bridge, and the resistors R₃, R₄, R₃′, and R₄′ may be connected to form a second Wheatstone Bridge.

FIG. 6A shows an embodiment in which all of the loops 602, 604, 606, 608 are formed on one surface of a substrate. FIG. 6B shows an elevation of an alternative embodiment, in which the loops 602 and 604 are formed on a first surface of a substrate 620, and the loops 606 and 608 are formed on a second surface of the substrate 620, with the second surface opposite the first surface. In the embodiment of FIG. 6B, the loops 606 and 608 may have the same diameters as loops 602 and 604, respectively. Alternatively, the loops 606 and 608 may have smaller diameters, similarly to what is shown in FIG. 6A.

A dual or quad loop strain gauge architecture need not depend on circular loops of resistors. In alternative embodiments, the loops may have oval, rectangular, square, or other shapes—and even irregular shapes—so long as the gap between concentric loops (or more specifically, concentric shapes) remains fixed (e.g., constant).

In some embodiments, additional sets of angularly-aligned resistors may be added to the strain gauge architecture shown in FIG. 2B, and the pixel count of the resultant force sensor may be increased beyond two pixels. FIG. 7 shows an example dual loop strain gauge architecture 700 in which each of an outer loop 702 and an inner loop 704 is segmented into more than two resistors (e.g., more than two strain-sensitive resistors), with corresponding pairs of outer and inner loop resistors having the same angular extent (or alternatively, different but generally aligned angular extents). For example, the architecture 700 includes four resistors disposed around the outer loop 702 and four resistors disposed around the inner loop 704. As shown, the resistor R₁ in the outer loop 702 has a one-to-one correspondence with the resistor R₂ in the inner loop 704, and both R₁ and R₂ span the same angular extent with respect to a center axis 706 of the dual loop strain gauge architecture 700. The corresponding resistors R₁ and R₂ (or resistor pair) may be electrically connected in a half bridge configuration.

In alternative embodiments, each of the outer and inner loops 702, 704 could have more or fewer resistors.

The dual loop strain gauge architecture 700 is useful, in some respects, in that it enables determinations about a pressure distribution associated with a load, in addition to a determination of a total load (or force) applied within the boundary defined by the dual loop strain gauge architecture 700.

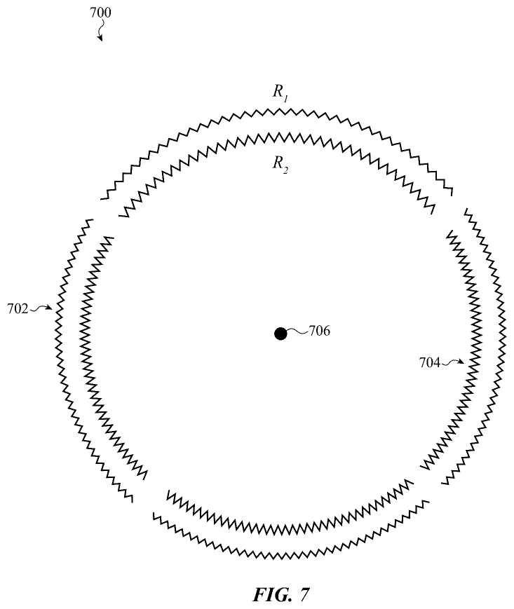

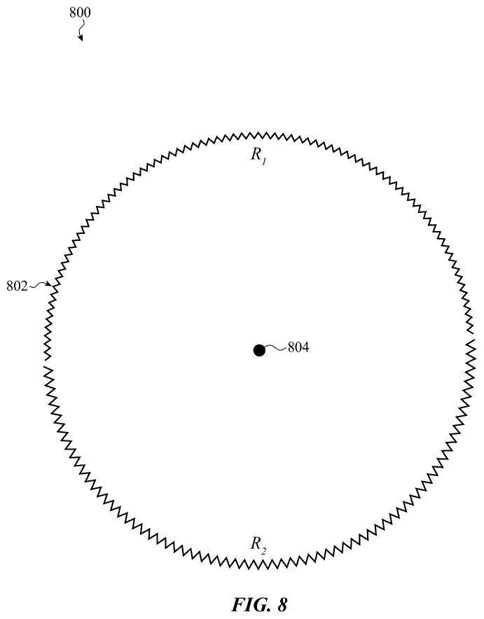

FIG. 8 shows an example single loop strain gauge architecture 800, which may also be used to obtain a correlation between force and strain. The architecture 800 includes a single loop 802 containing two resistors (e.g., two strain-sensitive resistors, R₁ and R₂).

The error associated with a determined strain value may be greater for a single loop strain gauge architecture 800 than for a dual loop (or other multiple loop) strain gauge architecture. The error may increase for a force associated with a force centroid that is further from the center of the single loop strain gauge architecture 800 (e.g., further from center axis 804).

In alternative embodiments, a single loop strain gauge architecture may include one, four, or other numbers of strain-sensitive resistors.

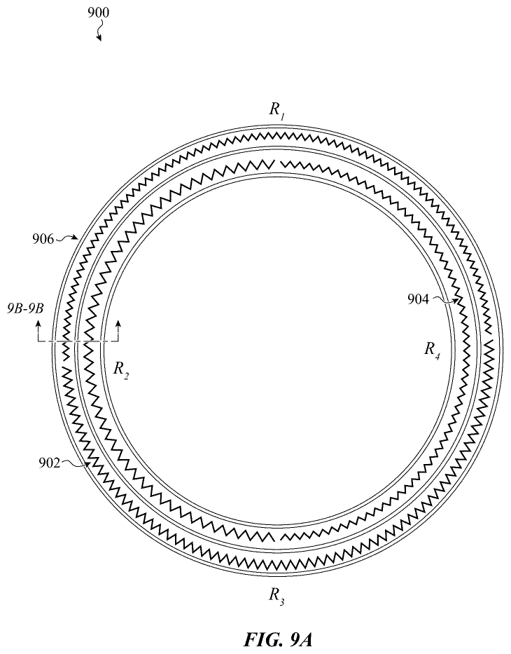

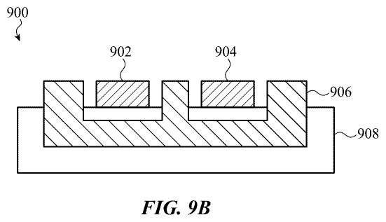

As shown in FIGS. 9A and 9B, one or more thermally-conductive materials (e.g., thermal short circuit paths) may be provided for a dual loop (or other multiple loop) strain gauge architecture 900. FIG. 9A shows a plan view of the architecture 900, and FIG. 9B shows a cross-sectional elevation of the architecture 900.

The thermally-conductive materials (e.g., thermal short circuit paths) may be provided around and/or between loops, to reduce thermal transient times and/or address thermal drift. By way of example, FIGS. 9A and 9B show a single element 906 that extends under, and in concentric circles around and between, each of an outer loop 902 and an inner loop 904. Each of the loops 902, 904 may include two or more resistors. In some embodiments, the element 906 may include one or more printed conductive traces and one or more conductive vias. In some embodiments, the element 906 may include a metallic component. In some embodiments, both the loops 902, 904 and the element 906 may be formed on, or attached to, a carrier substrate 908, such as a flexible printed circuit (FPC).

In some embodiments, the singular element 906 may be subdivided into two or more sectors or radial sections, with relatively small or relatively large radial gaps therebetween.

In some embodiments, the singular element 906 (or multiple elements) may only surround the outer and inner loops 902, 904, and not extend between the outer and inner loops 902, 904. In some embodiments, the singular element 906 (or multiple elements) may only extend between the outer and inner loops 902, 904 and not surround the outer and inner loops 902, 904. In some embodiments, the singular element 906 (or multiple elements) may only extend under the outer and inner loops 902, 904 and not around or between the outer and inner loops 902, 904. The singular element 906 (or multiple elements) may also be configured in other ways to reduce thermal transient times and/or address thermal drift. For example, the singular element 906 may be replaced by one or more circular traces that are disposed on a same surface of the substrate 908 as the loops 902, 904, but which do not extend below or under the loops 902, 904.

In any of the strain gauge architectures described herein, the resistors of the strain gauge architecture may be formed by FPC etching (e.g., etching the resistors in an FPC metal layer, such as a copper (Cu) foil or copper nickel (CuNi) foil, which can improve bending performance over the use of thin films), or by thin film deposition on an FPC (e.g., CuNi sputtered on a polyethylene terephthalate (PET) substrate, which allows for an undercoat that improves coefficient of thermal expansion (CTE) matching between loops), or by sputtering the resistors directly on a thin plate (e.g., CuNi or silicon carbide (SiC) sputtered on a glass, sapphire, or zirconia substrate, which eliminates the need for a polymer between the resistors and the thin plate structure on which they are formed). In the case of an FPC, the FPC may be bonded to a thin plate structure.

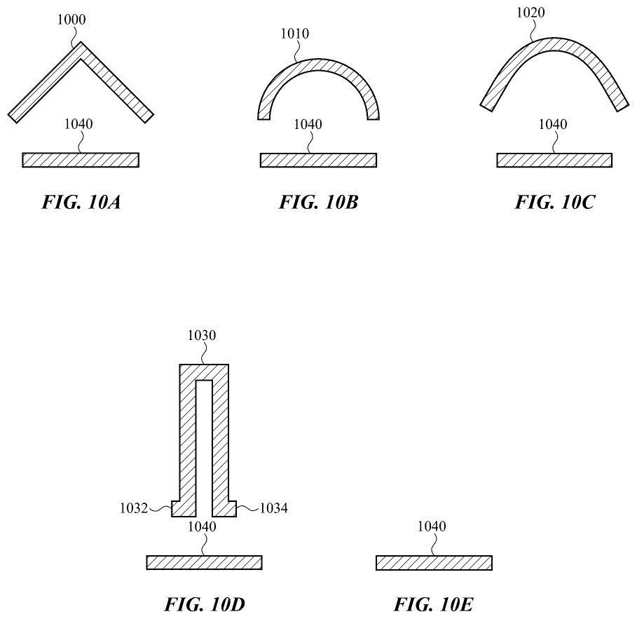

FIGS. 10A-10E show various alternative rosette elements that may be used in any of the strain gauge architectures described herein. FIG. 10A shows a sawtooth rosette element 1000, as already shown and described. A sawtooth rosette element may be equally responsive to radial strain (e.g., strain in a radial direction) and angular strain (e.g., strain in an angular direction). FIG. 10B shows a semicircle rosette element 1010. A semicircle rosette element may also be equally responsive to radial and angular strain. FIG. 10C shows a sine/cosine function rosette element 1020. The amplitude and period of the sine/cosine function may be adjusted, as desired, to make the sine/cosine function rosette element more or less sensitive to radial versus angular strain. FIG. 10D shows a radial dominant rosette element 1030. The radial dominant rosette element may or may not include connecting feet 1032, 1034 and may have an inward-opening rectangular shape. FIG. 10E shows an angular dominant rosette element 1040. The angular dominant rosette element may be generally insensitive to radial strain.

In the case of a strain gauge architecture having two or more loops, each loop may have the same or similar rosette elements. Alternatively, and as shown in FIGS. 10A-10D, different loops may have different rosette elements. For example, one loop (e.g., an outer loop) may have one of the types of rosette element 1000, 1010, 1020, 1030 shown in FIGS. 10A-10D, and another loop (e.g., an inner loop) may have the angular rosette element 1040 shown in each of FIGS. 10A-10E. Thus, for example, FIG. 10A shows a combination of a sawtooth rosette element 1000 and an angular dominant rosette element 1040. Because the angular dominant rosette element 1040 is primarily sensitive to angular strain, and angular strain is typically low for a transverse load applied to a thin plate strain gauge architecture, the angular dominant rosette element 1040 can be used for the purpose of sensing thermal strain, which thermal strain can be removed from the radial strain sensed by another type of rosette element. In other embodiments, different combinations of rosette elements in different loops may be provided (e.g., different types of rosette elements having different sensitivities to thermal strain); or different types of rosette elements may be used for different pixels or resistors within a pixel; or different types of rosette elements may be linked within a single resistor.

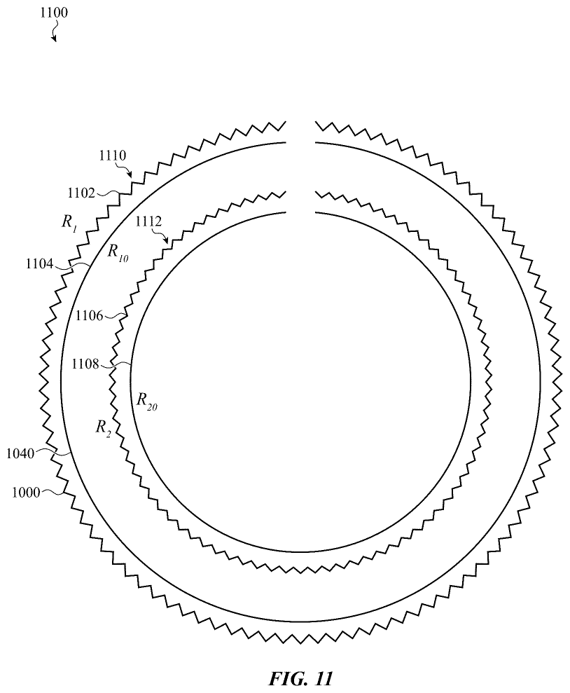

FIG. 11 shows a practical implementation of the rosette elements 1000, 1040 shown in FIG. 10A, in a quad loop strain gauge architecture 1100. As shown, the resistor of one loop 1102, 1106 in each loop pair 1110, 1112 (e.g., resistors R₁ and R₂) contains sawtooth rosette elements, and the resistor of the other loop 1104, 1108 in each loop pair 1110, 1112 (e.g., resistors R_{1θ} and R_{2θ}) contains angular dominant rosette elements.

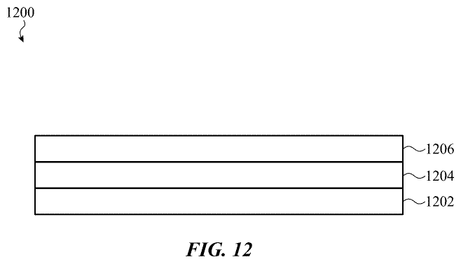

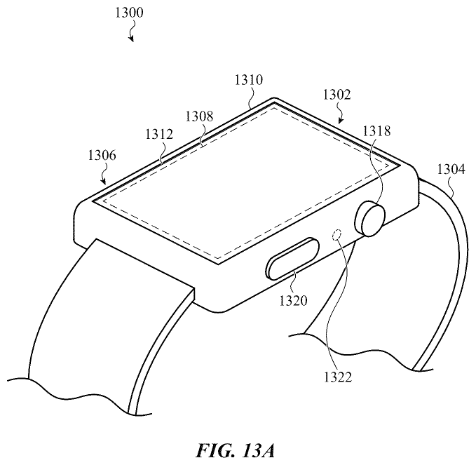

FIG. 12 shows a cross-section 1200 of a single loop of a strain gauge architecture. The loop includes a first material 1204 disposed (e.g., sputtered) on a substrate 1202 and having a TCR, and a second material 1206 disposed (e.g., sputtered) on the first material 1204 and having a second TCR. The second TCR may differ from the first TCR. In some embodiments, one of the materials 1204 or 1206 may have a positive TCR and the other material may have a negative TCR. An advantage of the loop composition shown in FIG. 12 is that it can self-compensate for thermal strain variations. In an alternative embodiment to what is shown, the first and second materials 1204, 1206 may be mixed (instead of being layered or stacked).

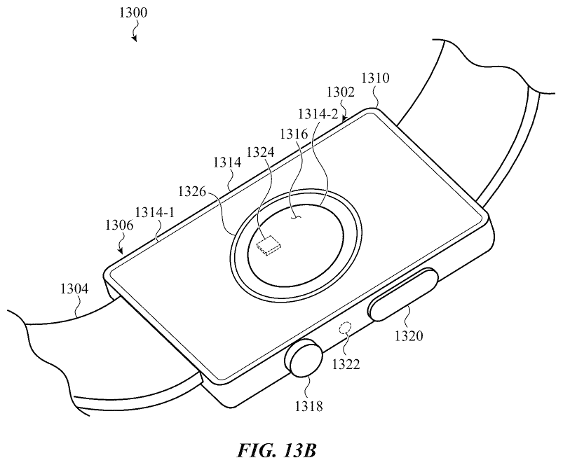

FIGS. 13A and 13B show an example of a device 1300 (an electronic device) that includes a strain gauge architecture 1326, such as any of the strain gauge architectures described herein. The strain gauge architecture 1326 may be used, for example, to determine a pressure applied to a back surface of the device 1300, or a status of the device 1300 (e.g., whether the device 1300 is being worn or a tightness of the device 1300). The device's dimensions and form factor, and inclusion of a band 1304 (e.g., a wrist band), suggest that the device 1300 is an electronic watch, fitness monitor, or health diagnostic device. However, the device 1300 could alternatively be any type of wearable device. FIG. 13A shows a front isometric view of the device 1300, and FIG. 13B shows a back isometric view of the device 1300.

The device 1300 may include a body 1302 (e.g., a watch body) and a band 1304. The body 1302 may include an input or selection device, such as a crown 1318 or a button 1320. The band 1304 may be attached to a housing 1306 of the body 1302, and may be used to attach the body 1302 to a body part (e.g., an arm, wrist, leg, ankle, or waist) of a user. The body 1302 may include a housing 1306 that at least partially surrounds a display 1308. In some embodiments, the housing 1306 may include a sidewall 1310, which sidewall 1310 may support a front cover 1312 (FIG. 13A) and/or a back cover 1314 (FIG. 13B). The front cover 1312 may be positioned over the display 1308, and may provide a window through which the display 1308 may be viewed. In some embodiments, the display 1308 may be attached to (or abut) the sidewall 1310 and/or the front cover 1312. In alternative embodiments of the device 1300, the display 1308 may not be included and/or the housing 1306 may have an alternative configuration.

The display 1308 may include one or more light-emitting elements including, for example, light-emitting elements that define a light-emitting diode (LED) display, organic LED (OLED) display, liquid crystal display (LCD), electroluminescent (EL) display, or other type of display. In some embodiments, the display 1308 may include, or be associated with, one or more touch and/or force sensors that are configured to detect a touch and/or a force applied to a surface of the front cover 1312.

In some embodiments, the sidewall 1310 of the housing 1306 may be formed using one or more metals (e.g., aluminum or stainless steel), polymers (e.g., plastics), ceramics, or composites (e.g., carbon fiber). The front cover 1312 may be formed, for example, using one or more of glass, a crystal (e.g., sapphire), or a transparent polymer (e.g., plastic) that enables a user to view the display 1308 through the front cover 1312. In some cases, a portion of the front cover 1312 (e.g., a perimeter portion of the front cover 1312) may be coated with an opaque ink to obscure components included within the housing 1306. In some cases, all of the exterior components of the housing 1306 may be formed from a transparent material, and components within the device 1300 may or may not be obscured by an opaque ink or opaque structure within the housing 1306.

The back cover 1314 may be formed using the same material(s) that are used to form the sidewall 1310 or the front cover 1312. In some cases, the back cover 1314 may be part of a monolithic element that also forms the sidewall 1310. In other cases, and as shown, the back cover 1314 may be a multi-part back cover, such as a back cover having a first back cover portion 1314-1 attached to the sidewall 1310 and a second back cover portion 1314-2 attached to the first back cover portion 1314-1. The second back cover portion 1314-2 may in some cases have a circular perimeter and an arcuate exterior surface 1316 (e.g., an exterior surface 1316 having an arcuate profile). In some embodiments, the second back cover portion 1314-2 may be an intended skin-contacting housing member of the device 1300. In the case of a second back cover portion 1314-2 having an arcuate exterior surface 1316, a more distal portion of the second back cover portion 1314-2 may be a skin contact region. Alternatively, in the case of a second back cover portion 1314-2 having a flat exterior surface, an entirety of the second back cover portion 1314-2 may define a skin contact region.

The front cover 1312, back cover 1314, or first back cover portion 1314-1 may be mounted to the sidewall 1310 using fasteners, adhesives, seals, gaskets, or other components. The second back cover portion 1314-2, when present, may be mounted to the first back cover portion 1314-1 using fasteners, adhesives, seals, gaskets, or other components.

A display stack or device stack (hereafter referred to as a “stack”) including the display 1308 may be attached (or abutted) to an interior surface of the front cover 1312 and extend into an interior volume of the device 1300. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 1312 (e.g., to a display surface of the device 1300).

In some cases, a force sensor (or part of a force sensor system) may be positioned within the interior volume below and/or to the side of the display 1308 (and in some cases within the device stack). The force sensor (or force sensor system) may be triggered in response to the touch sensor detecting one or more touches on the front cover 1312 (or a location or locations of one or more touches on the front cover 1312), and may determine an amount of force associated with each touch, or an amount of force associated with the collection of touches as a whole. The force sensor (or force sensor system) may alternatively trigger operation of the touch sensor (or touch sensor system), or may be used independently of the touch sensor (or touch sensor system).

The device 1300 may include various sensors. In some embodiments, the device 1300 may have a port 1322 (or set of ports) on a side of the housing 1306 (or elsewhere), and an ambient pressure sensor, ambient temperature sensor, internal/external differential pressure sensor, gas sensor, particulate matter concentration sensor, or air quality sensor may be positioned in or near the port(s) 1322. In some embodiments, the device 1300 may include an optical sensor 1324 that senses characteristics of a user, characteristics of an environment, and/or whether or how the device 1300 is worn, through the back cover 1314 (e.g., through the second back cover portion 1314-2). In other embodiments, the optical sensor 1324 may perform its sensing through the front cover 1312 (and in some cases through the display 1308), through the button 1320, through the top or ring of the crown 1318, or through the sidewall of the housing 1306. The device 1300 may also include a strain gauge architecture 1326. The strain gauge architecture 1326 may be disposed on or attached to the back cover 1314 (e.g., to the first back cover portion 1314-1, circumscribing the second back cover portion 1314-2 and/or the skin contact region).

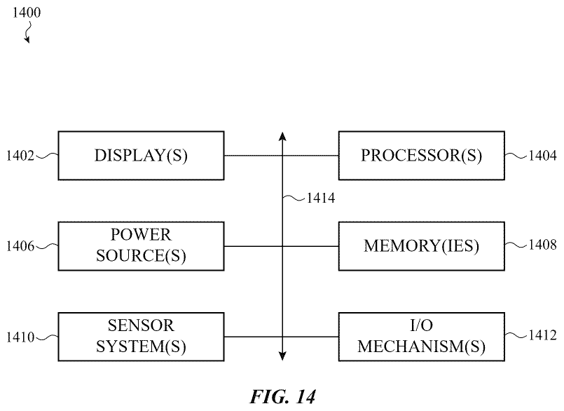

FIG. 14 shows an example electrical block diagram of an electronic device 1400, which electronic device 1400 may in some cases be an electronic device including one or more of the strain gauge architectures described herein. In some embodiments, the electronic device 1400 may be the electronic device described with reference to FIGS. 13A and 13B. The electronic device 1400 may optionally include an electronic display 1402 (e.g., a light-emitting display), a processor 1404, a power source 1406, a memory 1408 or storage device, a sensor system 1410, and/or an input/output (I/O) mechanism 1412 (e.g., an input/output device, input/output port, or haptic input/output interface). The processor 1404 may control some or all of the operations of the electronic device 1400. The processor 1404 may communicate, either directly or indirectly, with some or all of the other components of the electronic device 1400. For example, a system bus or other communication mechanism 1414 can provide communication between the electronic display 1402, the processor 1404, the power source 1406, the memory 1408, the sensor system 1410, and the I/O mechanism 1412.

The processor 1404 may be implemented as any electronic device capable of processing, receiving, or transmitting data or instructions, whether such data or instructions is in the form of software or firmware or otherwise encoded. For example, the processor 1404 may include a microprocessor, a central processing unit (CPU), an application-specific integrated circuit (ASIC), a digital signal processor (DSP), a control circuit, or a combination of such devices. As described herein, the term “processor” is meant to encompass a single processor or processing unit, multiple processors, multiple processing units, or other suitably configured computing element or elements. In some cases, the processor 1404 may provide part or all of the processing system or processor described herein.

It should be noted that the components of the electronic device 1400 can be controlled by multiple processors. For example, select components of the electronic device 1400 (e.g., the sensor system 1410) may be controlled by a first processor and other components of the electronic device 1400 (e.g., the electronic display 1402) may be controlled by a second processor, where the first and second processors may or may not be in communication with each other.

The power source 1406 can be implemented with any device capable of providing energy to the electronic device 1400. For example, the power source 1406 may include one or more batteries or rechargeable batteries. Additionally, or alternatively, the power source 1406 may include a power connector or power cord that connects the electronic device 1400 to another power source, such as a wall outlet. The power source 1406 may also or alternatively include a wireless charging circuit.

The memory 1408 may store electronic data that can be used by the electronic device 1400. For example, the memory 1408 may store electrical data or content such as, for example, audio and video files, documents and applications, device settings and user preferences, timing signals, control signals, instructions, and/or data structures or databases (including raw or processed measurements obtained from one or more of the strain gauge architectures described herein). The memory 1408 may include any type of memory. By way of example only, the memory 1408 may include random access memory, read-only memory, Flash memory, removable memory, other types of storage elements, or combinations of such memory types.

The electronic device 1400 may also include one or more sensor systems 1410 positioned almost anywhere on the electronic device 1400. The sensor system(s) 1410 may be configured to sense one or more types of parameters, such as but not limited to: vibration, light, touch, force, heat, movement, relative motion, biometric data (e.g., biological parameters) of a user, air quality, proximity, position, connectedness, surface quality, and so on. By way of example, the sensor system(s) 1410 may include one or more of the strain gauge architectures described herein, a heat sensor, a position sensor, a light or optical sensor, an accelerometer, a pressure transducer, a gyroscope, a magnetometer, a health monitoring sensor, an air quality sensor, and so on. Additionally, the one or more sensor systems 1410 may utilize any suitable sensing technology, including, but not limited to, interferometric, magnetic, resistive, capacitive, ultrasonic, resistive, optical, acoustic, piezoelectric, or thermal technologies.

The I/O mechanism 1412 may transmit or receive data from a user or another electronic device. The I/O mechanism 1412 may include the electronic display 1402, a touch sensing input surface, a crown, one or more buttons (e.g., a graphical user interface “home” button), one or more cameras (including an under-display camera), one or more microphones or speakers, one or more ports such as a microphone port, and/or a keyboard. Additionally, or alternatively, the I/O mechanism 1412 may transmit electronic signals via a communications interface, such as a wireless, wired, and/or optical communications interface. Examples of wireless and wired communications interfaces include, but are not limited to, cellular and Wi-Fi communications interfaces.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. An electronic device, comprising:
a substrate; and
a force sensor comprising at least one strain-sensitive resistor formed on or attached to the substrate, the at least one strain-sensitive resistor defining at least one loop bounding an area of the substrate, a loop of the at least one loop comprising a number of strain-sensitive resistors disposed end-to-end along a length of the loop, and each strain-sensitive resistor of the at least one strain-sensitive resistor comprising a set of rosette elements.

2. The electronic device of claim 1, wherein the number of strain-sensitive resistors consists of one strain-sensitive resistor.

3. The electronic device of claim 1, wherein the number of strain-sensitive resistors comprises two strain-sensitive resistors.

4. The electronic device of claim 1, wherein each strain-sensitive resistor in the at least one strain-sensitive resistor comprises:
a first branching electrode at a first end; and
a second branching electrode at a second end.

5. The electronic device of claim 1, wherein:
the loop is a first loop; and
the at least one loop comprises a second loop.

6. The electronic device of claim 5, wherein strain-sensitive resistors of the first loop and the second loop are electrically connected in a full Wheatstone bridge configuration.

7. The electronic device of claim 5, wherein strain-sensitive resistors of the first loop and the second loop are electrically connected in a half Wheatstone bridge configuration.

8. The electronic device of claim 5, wherein:
the first loop is an outer loop;
the second loop is an inner loop;
each strain-sensitive resistor in the first loop has a corresponding strain-sensitive resistor in the second loop; and
a first strain-sensitive resistor in the first loop has a smaller angular extent than a corresponding second strain-sensitive resistor in the second loop.

9. The electronic device of claim 5, wherein:
the first loop and the second loop form a first loop pair;
the at least one loop comprises a third loop and a fourth loop, the third loop and the fourth loop forming a second loop pair;
the first loop pair and the second loop pair are separated by a first separation distance;
the first loop and the second loop are separated by a second separation distance;
the third loop and the fourth loop are separated by a third separation distance; and
the first separation distance is greater than the second separation distance and greater than the third separation distance.

10. The electronic device of claim 9, wherein the first loop pair and the second loop pair are disposed on a surface of the substrate.

11. The electronic device of claim 9, wherein:
the substrate has a first surface opposite a second surface;
the first loop pair is disposed on the first surface; and
the second loop pair is disposed on the second surface.

12. The electronic device of claim 9, wherein:
the first loop and the second loop comprise a first material;
the third loop and the fourth loop comprise a second material; and
the second material is different from the first material.

13. The electronic device of claim 1, wherein the loop comprises:
a first material disposed on the substrate and having a first temperature coefficient of resistance (TCR); and
a second material disposed on the first material and having a second TCR, the second TCR different from the first TCR.

14. An electronic device, comprising:
a substrate; and
a force sensor comprising a set of strain-sensitive resistors formed on or attached to the substrate, the set of strain-sensitive resistors defining at least one loop pair bounding an area of the substrate, a loop pair of the at least one loop pair comprising a first loop and a second loop, the first loop comprising a first number of strain-sensitive resistors disposed end-to-end along a first length of the first loop, the second loop comprising a second number of strain-sensitive resistors disposed end-to-end along a second length of the second loop, and each strain-sensitive resistor of the at least one strain-sensitive resistor comprising a set of rosette elements.

15. The electronic device of claim 14, wherein:
each strain-sensitive resistor of the first number of strain-sensitive resistors has a first type of rosette element; and
each strain-sensitive resistor of the second number of strain-sensitive resistors has the first type of rosette element.

16. The electronic device of claim 14, wherein:
each strain-sensitive resistor of the first number of strain-sensitive resistors has a first type of rosette element; and
each strain-sensitive resistor of the second number of strain-sensitive resistors has a second type of rosette element, the second type of rosette element different from the first type of rosette element.

17. The electronic device of claim 16, wherein:
the first type of rosette element is sensitive to strain in at least a radial direction; and
the second type of rosette element is sensitive to strain in at least an angular direction.

18. The electronic device of claim 16, wherein the first type of rosette element and the second type of rosette element have different sensitivities to thermal strain.

19. The electronic device of claim 14, wherein:
the loop pair is a first loop pair;
the at least one loop pair comprises a second loop pair; and
the electronic device comprises a thermally-conductive material disposed on the substrate between the first loop pair and the second loop pair.

20. A wearable device, comprising:
a housing defining a skin-contacting housing member, the skin-contacting housing member having a skin contact region; and
a force sensor comprising a set of strain-sensitive resistors formed on or attached to the skin-contacting housing member, the set of strain-sensitive resistors defining at least one loop circumscribing the skin contact region, a loop of the at least one loop comprising a number of strain-sensitive resistors disposed end-to-end along a length of the loop, and each strain-sensitive resistor of the at least one strain-sensitive resistor comprising a set of rosette elements.
